(19) United States
(12) Patent Application Publication
(10) Pub. No.: US 2026/0112686 A1
(43) Pub. Date: Apr. 23, 2026

(54) Viscoelastic Inorganic Glass Solid Electrolytes For Lithium Or Sodium Batteries

(71) Applicant: Massachusetts Institute of Technology, Cambridge, MA (US)

(72) Inventors: Ju Li, Weston, MA (US); Tao Dai, Somerville, MA (US)

(73) Assignee: Massachusetts Institute of Technology, Cambridge, MA (US)

(21) Appl. No.: 18/918,599

(22) Filed: Oct. 17, 2024

Related U.S. Application Data
(60) Provisional application No. 63/614,105, filed on Dec. 22, 2023.
(60) Provisional application No. 63/657,369, filed on Jun. 7, 2024.

(51) Int. Cl. H01M 10/0562; H01M 10/052; H01M 10/054

(52) U.S. Cl. CPC H01M 10/0562; H01M 10/052; H01M 10/054; H01M 2300/008

(57) ABSTRACT

Described herein is a viscoelastic inorganic glass solid electrolyte material, comprising: LiₓAlE_{y}G_{z}Jₘ, or NaₓAlE_{y}G_{z}Jₘ, wherein E denotes one or more elements selected from the group consisting of boron (B), phosphorus (P), silicon (Si), lanthanum (La), or cerium (Ce), G is a chalcogen element, J is a halide element, and wherein 0<x<5, 0<y<5, 0<z<5, and m=x+ny−2z+3, wherein n=3 when E denotes at least one element selected from the group consisting of La, Ce and B; n=4 when E denotes Si; and n=5 when E denotes P. In some embodiments, E is one element selected from the group consisting of B, P, Si, La, or Ce.

### CROSS REFERENCE TO RELATED APPLICATIONS

This application claims the benefit under 35 U.S.C. § 119 of U.S. Provisional Patent Application No. 63/614,105 filed on Dec. 22, 2023, and U.S. Provisional Patent Application No. 63/657,369 filed on Jun. 7, 2024, which are hereby incorporated by reference herein in their entirety.

### STATEMENT REGARDING FEDERALLY SPONSORED RESEARCH

This invention was made with government support under HR0011-22-C-0097 awarded by the Defense Advanced Research Projects Agency. The government has certain rights in the invention.

### BACKGROUND

Glass can occupy an amorphous state, meaning a non-crystalline state or semicrystalline state with amorphous regions. In an amorphous state, glass will transit from a hard and relatively brittle state, which can be referred to as a glassy state, into a viscous or rubbery state when the temperature is higher than or close to the glass transition temperature (T_{g}). Glass in a viscous or rubbery state can be highly deformable, which is useful in a number of applications. Glass occupies a metastable state, and theoretically, will undergo an aging processes. During the aging process, the internal disordered structure will gradually become ordered, and the degree of vitrification will continue to decrease. When the ambient temperature is higher than T_{g}, the aging process will accelerate.

### SUMMARY OF DISCLOSED EMBODIMENTS

In one aspect, the present disclosure is directed towards a viscoelastic inorganic glass solid electrolyte material, comprising: LiₓAlE_{y}G_{z}Jₘ, or NaₓAlE_{y}G_{z}Jₘ, wherein E denotes one or more elements selected from the group consisting of boron (B), phosphorus (P), silicon (Si), lanthanum (La), or cerium (Ce), G is a chalcogen element, J is a halide element, and wherein 0<x<5, 0<y<5, 0<z<5, and m=x+ny−2z+3, wherein n=3 when E denotes at least one element selected from the group consisting of La, Ce and B; n=4 when E denotes Si; and n=5 when E denotes P.

In some embodiments, E is one element selected from the group consisting of B, P, Si, La, or Ce. In some embodiments, the chalcogen element comprises one of: oxygen (O); sulfur (S); or selenium (Se). In some embodiments, the halide element comprises one of: fluorine (F); chlorine (Cl); bromine (Br); or iodine (I). In some embodiments, E is B, P, or Si. In some embodiments, E is La or Ce and the following mathematical formula is satisfied m=x+3y−2z+3. In some embodiments, G denotes oxygen (O). In some embodiments, G denotes O and E is B, P, or Si. In some embodiments, G denotes O, E is La or Ce, and the following mathematical formula is satisfied m=x+3y−2z+3. In some embodiments, E is P, G is O, J is Cl and the following mathematical formula is satisfied m=x+5y−2z+3.

According to another aspect of the disclosure, a battery comprises a positive electrode; an electrolyte layer disposed on the positive electrode, wherein the electrolyte layer comprises a viscoelastic inorganic glass solid electrolyte material, comprising: LiₓAlE_{y}G_{z}Jₘ, or NaₓAlE_{y}G_{z}Jₘ, wherein E denotes at least one or more elements selected from the group consisting of boron (B), phosphorus (P), silicon (Si), lanthanum (La), or cerium (Ce), G is a chalcogen element, J is a halide element, and wherein 0<x<5, 0<y<5, 0<z<5, and m=x+ny−2z+3, wherein n=3 when E denotes at least one element selected from the group consisting of La, Ce and B; n=4 when E denotes Si; n=5 when E denotes P; and a negative electrode disposed on the electrolyte layer.

In some embodiments, E is one element selected from the group consisting of B, P, Si, La, or Ce. In some embodiments, there are no crystalline peaks within the electrolyte layer when tested in an X-ray diffractometer. In some embodiments, the battery further comprises one or more passivation layers in the electrolyte layer. In some embodiments, the battery further comprises one or more passivation layers in the electrolyte layer and the passivation layers contain either glass forming elements or their reduction products. In some embodiments, G denotes oxygen (O). In some embodiments, E is P, G is O, J is Cl and the following mathematical formula is satisfied m=x+5y−2z+3.

According to another aspect of the disclosure, a method for forming a battery comprising: providing a positive electrode; disposing an electrolyte layer on the positive electrode, wherein the electrolyte layer comprises a viscoelastic inorganic glass solid electrolyte material, comprising: LiₓAlE_{y}G_{z}Jₘ, or NaₓAlE_{y}G_{z}Jₘ, wherein E is phosphorus (P), G is oxygen (O), J is chlorine (Cl), and the following mathematical formula is satisfied 0<x<5, 0<y<5, 0<z<5, and m=x+5y−2z+3; rolling the electrolyte layer to a desired thickness by utilizing a hot forming process; and, disposing a negative electrode on the electrolyte layer.

In some embodiments, rolling the electrolyte layer is carried out with a roller. In some embodiments, there are no crystalline peaks within the electrolyte layer when tested in an X-ray diffractometer.

### DESCRIPTION OF THE SEVERAL VIEWS OF THE DRAWINGS

The manner and process of making and using the disclosed embodiments may be appreciated by reference to the figures of the accompanying drawings. It should be appreciated that the components and structures illustrated in the figures are not necessarily to scale, emphasis instead being placed upon illustrating the principals of the concepts described herein. Like reference numerals designate corresponding parts throughout the different views. Furthermore, embodiments are illustrated by way of example and not limitation in the figures, in which:

FIG. 1A is a perspective view of an example embodiment of a viscoelastic inorganic glass solid electrolyte material mixed to induce a mechanical deformity;

FIG. 1B is a perspective view of the example embodiment of the viscoelastic inorganic glass solid electrolyte material of FIG. 1A, stretched to induce a mechanical deformity;

FIG. 1C is a diagram of a structure of the viscoelastic inorganic glass solid electrolyte material of FIGS. 1A-1B;

FIG. 2A is a perspective view of an example embodiment of a viscoelastic inorganic glass solid electrolyte material mixed to induce a mechanical deformity;

FIG. 2B is a perspective view of the example embodiment of the viscoelastic inorganic glass solid electrolyte material of FIG. 2A, stretched to induce a mechanical deformity;

FIG. 3 is an exemplary schematic of a electrochemical cell, including a viscoelastic inorganic glass solid electrolyte material;

FIG. 4 is a block diagram of a method to form an electrochemical cell, such as the electrochemical cell in FIG. 3;

FIG. 5 is a result of cyclic voltammetry (CV) testing on a three electrode system with a LiAlP_{0.5}ClO_{1.25} electrolyte and a Li/Li⁺ reference electrode;

FIG. 6 is a graph of voltage vs. time for a Li/LiAlLa_{0.329}Cl_{3.5}O_{0.75}/Li cell in a constant current charge and discharge test at 0.1 mA/cm²; and

FIG. 7 is a graph of voltage vs. time for a Li/LACO/Li cell in a constant current charge and discharge test at 0.1 mA/cm².

### DETAILED DESCRIPTION

Before describing the broad concepts, devices, systems, and techniques sought to be protected herein, some introductory concepts are explained. One kind of conventional glass electrolyte is MACO, where M stands for lithium (Li) or sodium (Na), A stands for aluminum (Al), C stands for chlorine (Cl), and O stands for oxygen (O). Accordingly, LACO refers to an embodiment where L stands for lithium, which may be, for example, be represented by the formula: LiAlCl_{2.5}O_{0.75}.

Conventional MACO glass electrolytes demonstrate mechanical deformability at room temperature (about 25° C.+/−2° C.), resulting from the glass transition temperature (T_{g}) of MACO, which is lower than room temperature. When the ambient temperature is higher than the T_{g}, the mechanical deformability of conventional MACO glass electrolytes decreases after being stored for a period of time following synthesis. On the other hand, the reduction potentials of MACO are 1.45 V vs. Li/Li⁺ (for a MACO electrolyte where M stands for Li) and 1.55 V vs. Na/Na⁺ (for a MACO electrolyte where M stands for Na). Thus, MACO electrolytes are not stable with an anode with a redox potential lower than 1.45 V (for a MACO electrolyte where M stands for Li) and 1.55 V (for a MACO electrolyte where M stands for Na), let alone with lithium or sodium metal anodes.

Concepts described herein are directed towards adding glass forming agents into the MACO, resulting in a viscoelastic inorganic glass solid electrolyte material, which enhances the compatibility with the metal electrode, specifically lithium and/or sodium, and improves the mechanical deformability. The additional glass forming elements include boron (B), phosphorus (P), silicon (Si), lanthanum (La), and cerium (Ce).

Accordingly, disclosed herein is a class of viscoelastic inorganic glass solid electrolyte material represented by the following chemical formula: LiₓAlE_{y}G_{z}Jₘ, or NaₓAlE_{y}G_{z}Jₘ, where E denotes one or more elements selected from the group consisting of boron (B), phosphorus (P), silicon (Si), lanthanum (La), or cerium (Ce), G is a chalcogen element, J is a halide element, and where 0<x<5, 0<y<5, 0<z<5, and m=x+ny−2z+3. n=3 when E denotes at least one element selected from the group consisting of La, Ce and B; n=4 when E denotes Si; and n=5 when E denotes P.

According to an embodiment, E is one element selected from the group consisting of B, P, Si, La, or Ce. According to an embodiment, E is B, P, or Si. According to an embodiment, E is La or Ce and the following mathematical formula is satisfied m=x+3y−2z+3. According to an embodiment, E is P, G is O, J is Cl and the following mathematical formula is satisfied m=x+5y−2z+3. The chalcogen element comprises one of: oxygen (O); sulfur (S); or selenium (Se). The halide element comprises one of: fluorine (F); chlorine (Cl); bromine (Br); or iodine (I). According to an embodiment, G denotes oxygen (O). In an embodiment where G denotes oxygen (O), E is B, P, or Si. In an embodiment where G denotes oxygen (O), E is La or Ce and the following mathematical formula is satisfied m=x+3y−2z+3.

By including certain glass forming elements (i.e., B, P, Si, La, Ce) in the MACO electrolytes, the disclosed viscoelastic inorganic glass solid electrolyte has improved and long-lasting (or more durable) mechanical deformability characteristics compared with conventional MACO electrolytes. This is due to the glass forming elements, which provide a network by forming additional chemical bonds with adjacent atoms. The network creates or further enhances the amorphous structure of the glass. Further, said bonds contribute to the stability and durability of the glass by helping to prevent crystallization (meaning aging).

Additionally, the glass forming elements can further enhance the electrochemical compatibility with the electrodes, compared with conventional solid electrolytes. The glass forming elements can prevent the continuous decomposition of the electrolytes by forming passivation layers, when the disclosed viscoelastic inorganic glass solid electrolyte is reduced. The passivation layers will contain either the glass forming elements or their reduction products, both of which are compatible with Li and Na metals.

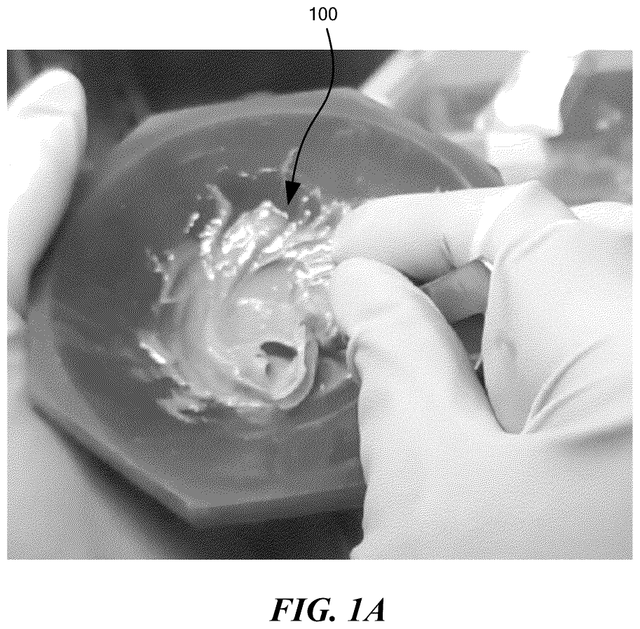

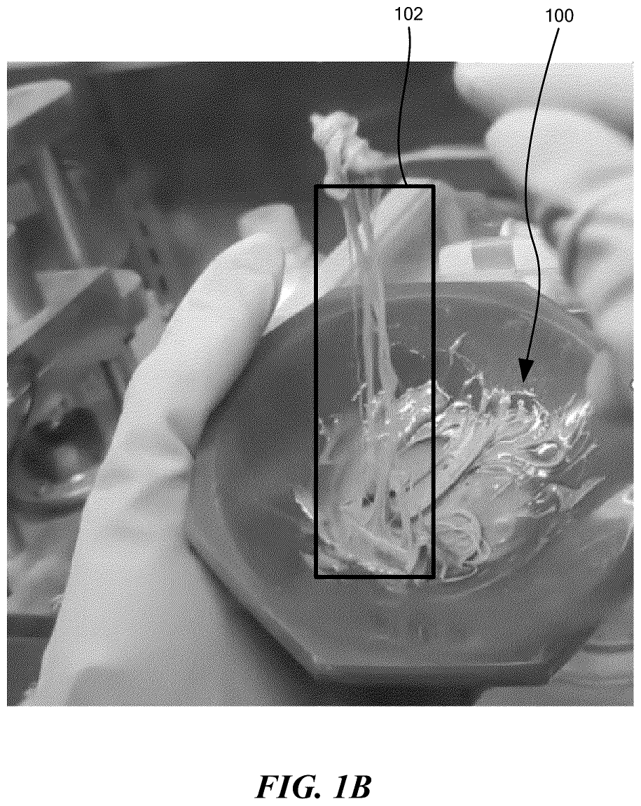

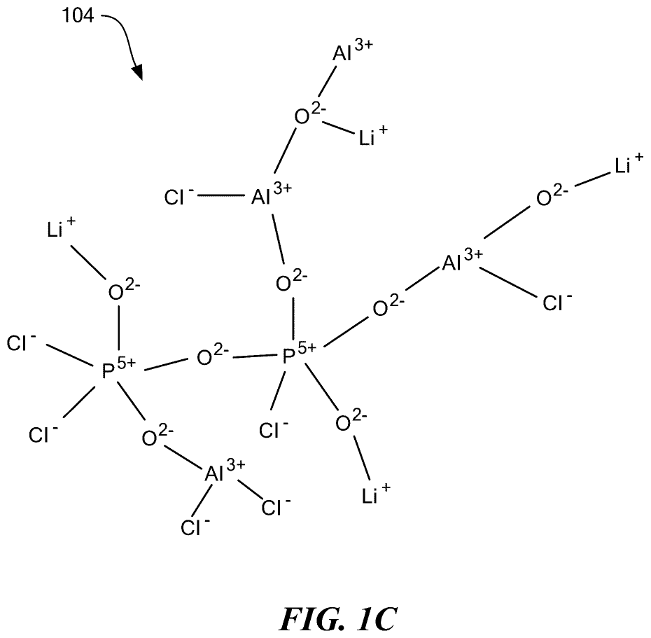

FIGS. 1A-1C illustrate an example embodiment of a viscoelastic inorganic glass solid electrolyte material. FIG. 1A is a perspective view of a viscoelastic inorganic glass solid electrolyte material 100, mixed to induce a mechanical deformity. The formula for the viscoelastic inorganic glass solid electrolyte material 100 is: LiAlP_{0.5}ClO_{1.25} (which may be referred to herein as ‘LAPCO’). The electrolyte material LiAlP_{0.5}ClO_{1.25} is made by mixing P₂O₅ with LiAlCl₄ in the molar ratio of 1:4 by hand grinding and heating the composition at 200° C. for 30 minutes. The synthesis method utilized in forming LAPCO does not affect the compatibility of LAPCO with an Li metal anode. The material 100 exhibits improved mechanical deformability and higher viscosity compared to conventional LACO (for example a conventional composition with the following formula: LiAlCl_{2.5}O_{0.75}). Specifically, the viscoelastic inorganic glass solid electrolyte material 100 includes dual physical properties, meaning the material 100 has a fluid's viscosity and the elasticity of a solid.

FIG. 1B is a perspective view of the viscoelastic inorganic glass solid electrolyte material 100, as disclosed in FIG. 1A, stretched to induce a mechanical deformity. As the material 100 is stretched, it maintains viscous like properties. As the material 100 is removed from the mortar, the material 100 deforms. Resultingly, the material lengthens, as illustrated for example in FIG. 1B in region 102.

FIG. 1C is a diagram of a structure 104 of the viscoelastic inorganic glass solid electrolyte material 100 of FIGS. 1A-1B. The addition of phosphorus is, in part, why LiAlP_{0.5}ClO_{1.25} has improved mechanical deformability compared with conventional LACO (for example a conventional composition with the following formula: LiAlCl_{2.5}O_{0.75}). The addition of phosphorus creates a plurality of networks by connecting all of the adjacent atoms together, due to the multivalence nature of P⁵⁺. This contributes to the stability and durability of the glass by helping to prevent crystallization, meaning it prevents aging. Age for the electrolyte is a relation of time, the number of deformations the electrolyte undergoes. Disruptions in the structure (such as notable deformations or striations) of the electrolyte following multiple deformations do not indicate aging, but instead indicate fatigue of the electrolyte.

Additionally, the resulting mechanical properties are produced in part because the all the materials utilized in the electrolyte are glass and thus, do not have a defined molecular structure, meaning they are totally amorphous. In part as a result of the addition of phosphorus, the reduction potential of LAPCO is 0.3 V, which is notably lower than the 1.45 V of conventional LACO.

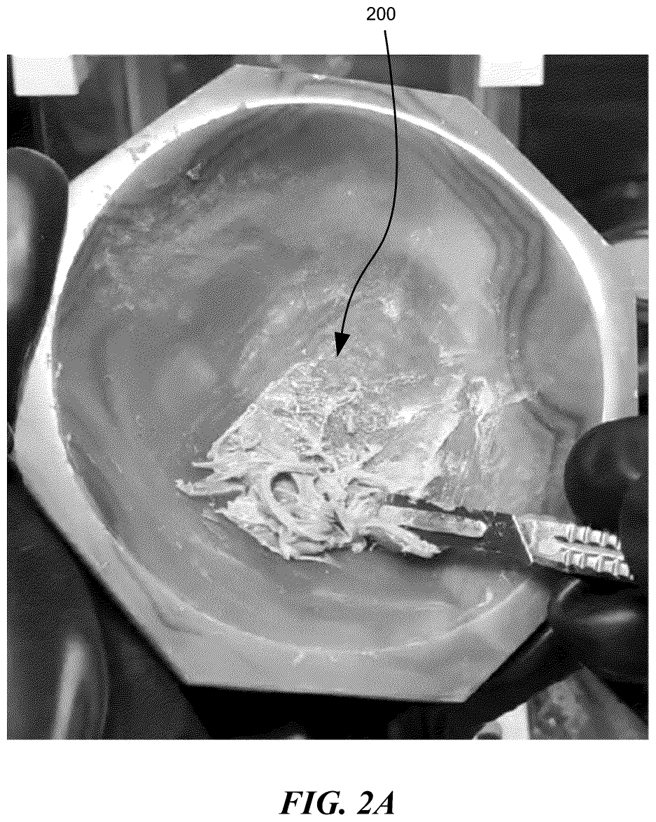

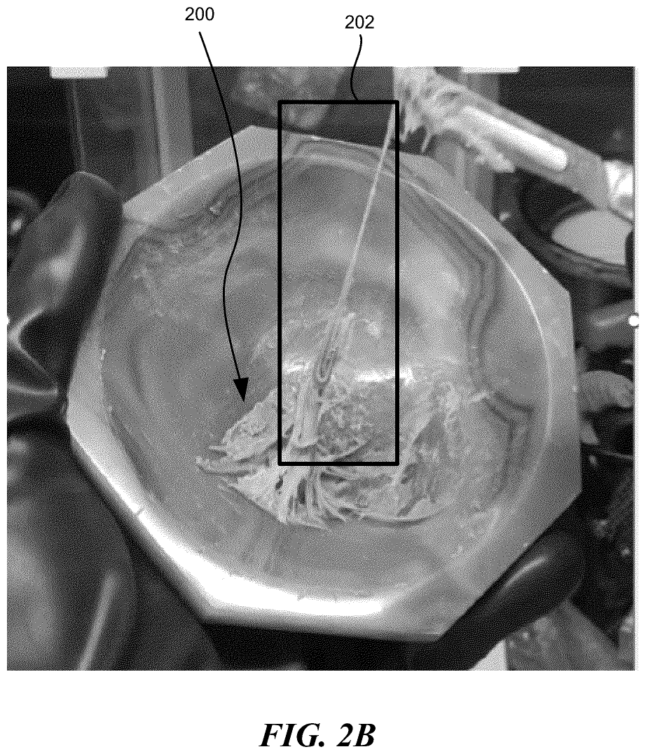

FIGS. 2A-2B illustrate an example embodiment of a viscoelastic inorganic glass solid electrolyte material. FIG. 2A is a perspective view of an example embodiment of a viscoelastic inorganic glass solid electrolyte material 200. Material 200 includes LaCl₃ in LACO, resulting in the formula: LiAlLa_{0.329}Cl_{3.5}O_{0.75}. The material 200 is made by mixing LiAlCl_{2.5}O_{0.75} (LACO) with LaCl₃ in the weight ratio of 5:3 by hand grinding and heating the composition at 200° C. for 30 minutes. The material 200 demonstrates improved deformability.

FIG. 2B is a perspective view of the example embodiment of the viscoelastic inorganic glass solid electrolyte material 200 of FIG. 2A, stretched in a first stretch to induce a mechanical deformity. As the material 200 is removed from the dish, the material 200 deforms. Resultingly, the material lengthens, as illustrated for example in FIG. 1B in region 202. The legend of the material 200 in region 202 illustrates the notable viscous properties of the material 200. As discussed above, age of the material 200 is related to time not the number of deformations, meaning that multiple deformations do not indicate aging, but fatigue of the material 200.

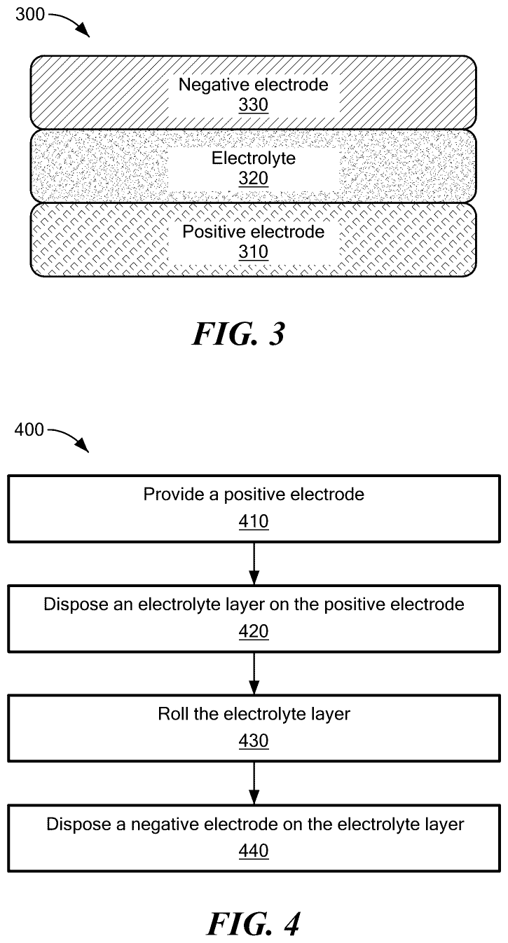

FIG. 3 is an exemplary schematic of a electrochemical cell (which may be referred to herein as a battery) 300, including the disclosed viscoelastic inorganic glass solid electrolyte material. An electrolyte layer 320 is disposed on a positive electrode 310. A negative electrode 330 is disposed on the electrolyte layer 320. The electrolyte layer 320 separates the negative electrode 330 and the positive electrode 310. The electrolyte layer 320 is used to conduct ions, but not electrons.

In an embodiment, the electrolyte layer 320 comprises a viscoelastic inorganic glass solid electrolyte material, such as the material 100 or the material 200. The viscoelastic inorganic glass solid electrolyte material is represented by the following chemical formula: LiₓAlE_{y}G_{z}Jₘ, or NaₓAlE_{y}G_{z}Jₘ, where E denotes at least one or more elements selected from the group consisting of boron (B), phosphorus (P), silicon (Si), lanthanum (La), or cerium (Ce), G is a chalcogen element, J is a halide element, and where 0<x<5, 0<y<5, 0<z<5, and m=x+ny−2z+3, where n=3 when E denotes at least one element selected from the group consisting of La, Ce and B; n=4 when E denotes Si; and n=5 when E denotes P.

According to an embodiment, E is one element selected from the group consisting of B, P, Si, La, or Ce. According to an embodiment, G denotes oxygen (O). According to an embodiment, E is P, G is O, J is Cl and the following mathematical formula is satisfied m=x+5y−2z+3. According to an embodiment, there are no crystalline peaks within the electrolyte layer when tested in an X-ray diffractometer. The battery may further comprise one or more passivation layers in the electrolyte layer. The passivation layers contain either glass forming elements or their reduction products. The electrolyte layer 320 may be rolled to a desired thickness by utilizing a hot forming process. Rolling the electrolyte layer is carried out with a roller.

Referring to FIG. 4, an example of a method that may be used to form a battery is method 400. For example, method 400 may be used to form the electrochemical cell 300. The method 400 provides a positive electrode in a first block 410. In a second block 420, method 400 disposes an electrolyte layer on the positive electrode. The electrolyte layer includes a viscoelastic inorganic glass solid electrolyte material, such as the material 100 or the material 200. The viscoelastic inorganic glass solid electrolyte material represented by the following chemical formula: LiₓAlE_{y}G_{z}Jₘ, or NaₓAlE_{y}G_{z}Jₘ, where E is phosphorus (P), G is oxygen (O), J is chlorine (Cl), and the following mathematical formula is satisfied 0<x<5, 0<y<5, 0<z<5, and m=x+5y−2z+3.

In a third block 430, method 400 rolls the electrolyte layer. In embodiments, the method includes rolling the electrolyte layer to a desired thickness by utilizing a hot forming process. Rolling the electrolyte layer is carried out with a roller. The roller may be a stainless steel roller.

In a fourth block 440, method 400 disposes a negative electrode on the electrolyte layer. In embodiments, there are no crystalline peaks within the electrolyte layer when tested in an X-ray diffractometer.

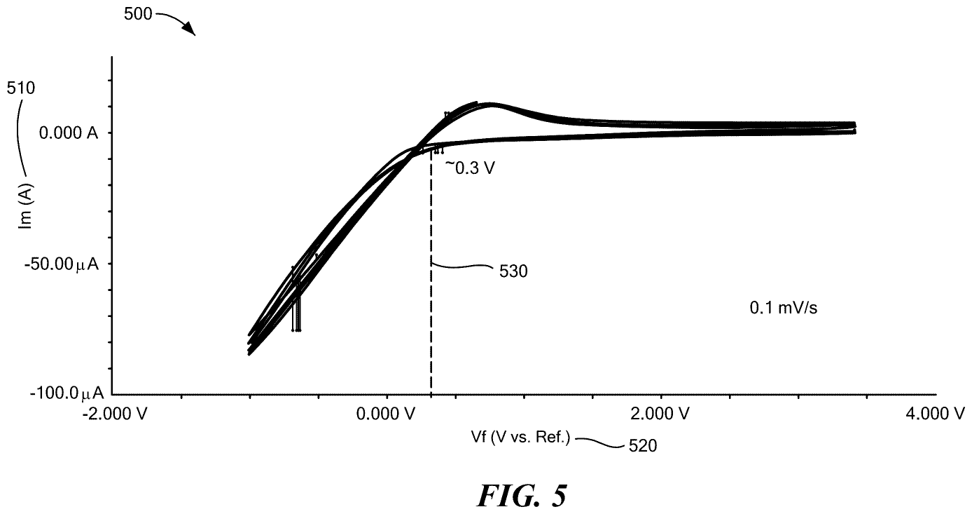

FIG. 5 is a result 500 of cyclic voltammetry (CV) testing, with current (amps) 510 shown on the y-axis and potential (volts) 520 shown in the x-axis, performed on a three electrode system with a LiAlP_{0.5}ClO_{1.25} electrolyte and a Li/Li⁺ reference electrode. The sweeping rate of potential is 0.1 mV/s. The lowest and highest potentials are −1.0 V and 3.5 V vs. Li/Li⁺, respectively. The line 530 marks the reduction potential of the LiAlP_{0.5}ClO_{1.25} electrolyte, which is about 0.3 V (+/−0.01 V) vs. Li/Li⁺. The reduction potential of the disclosed LiAlP_{0.5}ClO_{1.25} electrolyte is lower than that of conventional LACO, which has a reduction potential of 1.45 V. The reduction potential of the disclosed LiAlP_{0.5}ClO_{1.25} electrolyte further demonstrates the improved compatibility with Li metal.

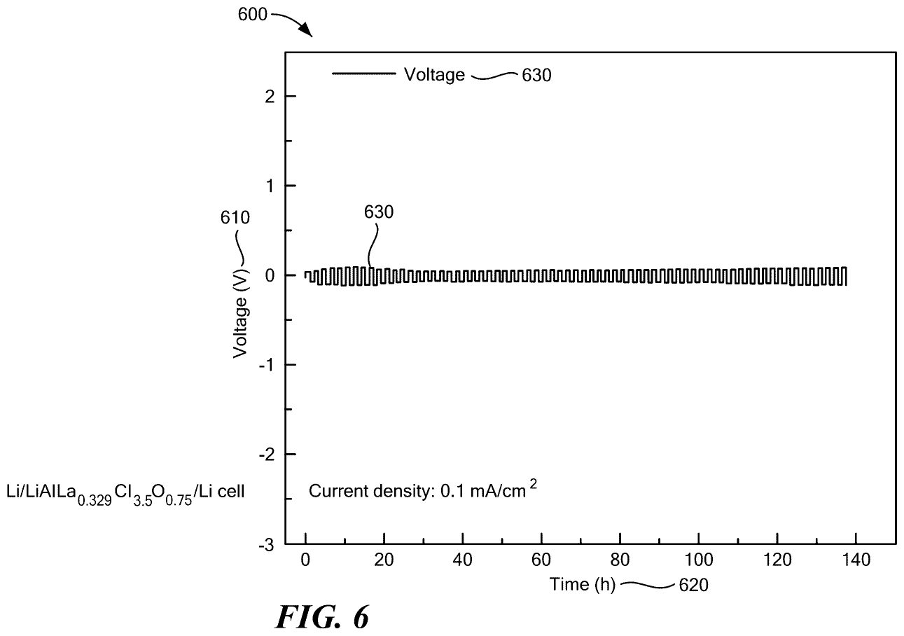

FIG. 6 is a graph 600 of voltage (volts) 610 vs. time (hours) 620, illustrating voltage in a line 630. Graph 600 discloses the voltage curve in line 630 for a Li/LiAlLa_{0.329}Cl_{3.5}O_{0.75}/Li cell, meaning a cell with negative and positive electrodes comprising Li and an electrolyte material layer comprising LiAlLa_{0.329}Cl_{3.5}O_{0.75}, in a constant current charge and discharge test at 0.1 mA/cm². The current density is 0.1 mA/cm². The cell was cycled at 0.1 mA/cm² at 25° C. As demonstrated by graph 600, in the earlier stages of the cycle, the cell undergoes a stabilization process, after which the voltage polarization remains stable. This stability demonstrates the compatibility of LiAlLa_{0.329}Cl_{3.5}O_{0.75} with Li metal.

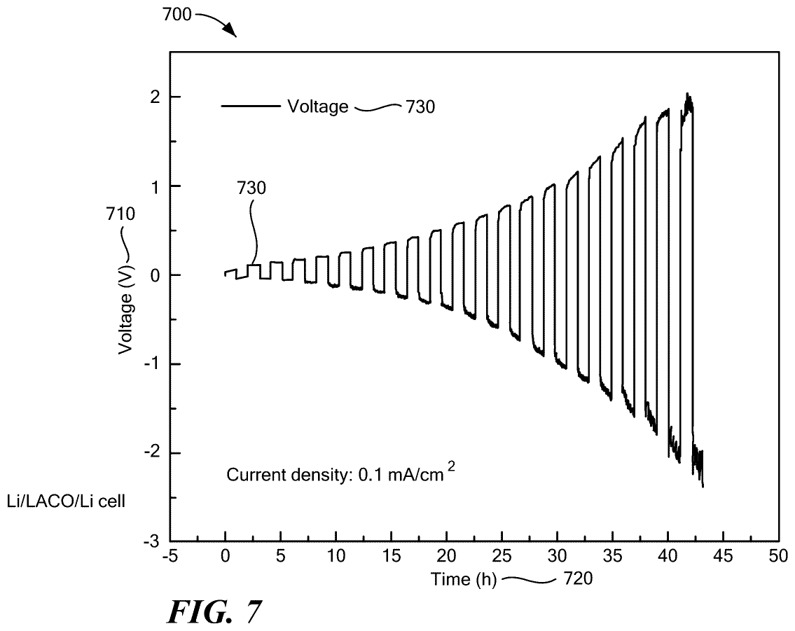

FIG. 7 is a graph 700 a graph 700 of voltage (volts) 710 vs. time (hours) 720, illustrating voltage in a first line 730. Graph discloses the voltage curves in line 730 for a Li/LACO/Li cell, meaning a cell with negative and positive electrodes comprising Li and an electrolyte material layer comprising LACO, in a constant current charge and discharge test at 0.1 mA/cm². The cell was cycled at 0.1 mA/cm² at 25° C. As demonstrated by graph 700, the voltage polarization continuously increases during cycling, indicating the LACO is not stable with Li metal. Comparing the voltage curves of FIG. 6 and FIG. 7, it can be concluded that the LiAlLa_{0.329}Cl_{3.5}O_{0.75} has a notably higher compatibility with an Li metal electrode.

The disclosed viscoelastic inorganic glass solid electrolyte material provides a number of different benefits. When the disclosed viscoelastic inorganic glass solid electrolyte was tested in an X-ray diffractometer, it was found there were no crystalline peaks. Further, after the aging process of half of a year, there notably were still no crystalline peaks. In comparison, for conventional MACO electrolytes, some faint crystalline peaks appeared after the same aging period of half of a year. The absence of crystalline peaks in the testing of the disclosed viscoelastic inorganic glass solid electrolyte verifies that the amorphous structure of the resulting solid electrolyte was maintained and the aging rate was greatly slowed. Moreover, the mechanical deformability of the disclosed viscoelastic inorganic glass solid electrolyte is greatly enhanced and almost does not decrease over time, which further demonstrates the improved and more durable mechanical deformability characteristics compared with conventional MACO electrolytes.

There are a number of benefits resulting from the disclosed viscoelastic inorganic glass solid electrolyte, specifically the electrolyte is cheaper and easier to manufacture due to the lower temperatures used and the hot forming process the electrolyte is compatible with. Conventional processes for forming free-standing solid-state electrolyte membranes may call for sintering for crystalline ceramics or for high stacking pressure (greater than 2 MPa) to be maintained during operation. In typical sintering, to get the electrolytes to full density, high temperatures (e.g., about 1000° C.+/−10° C.) are needed and are necessary for long periods of time (e.g., about 20 hours +/−1 hour). The higher temperature and time is called for because the initial composite begins with a powder and, because the chemicals used are crystalline, they do not deform easily. Accordingly, the battery is challenging and costly to manufacture.

Alternatively, other typical semiconductor processing techniques can be used (e.g., vapor deposition, etc.), which are challenging to scale as they can become costly and complex. In addition, the high stacking pressure (greater than 2 MPa) in operation is not practical for most application scenarios and the necessity of complex fixtures to provide the pressure also further reduces the energy density of the batteries.

In comparison, the viscoelastic inorganic glass solid electrolyte provided in accordance with the concepts described herein, can be used in a hot forming process. Use of a hot forming process results in batteries which are easier and less expensive to manufacture at scale than conventional batteries manufactured using sintering process, semiconductor process, or high-stacking-operation-pressure-needed process. The compositions provided in accordance with the concepts described herein can be rolled (e.g., with a stainless steel roller) to a desired thickness by utilizing a hot forming process, because they are soft and viscous at low temperatures due to the low T_{g}. This means less time and lower temperatures can be used, making the material easily manufacturable.

Another added benefit is that the T_{g} of the disclosed viscoelastic inorganic glass solid electrolyte, in some cases, can be lower than room temperature (about 25° C.+/−2° C.). So, the electrolyte is viscoelastic (meaning both viscous and elastic) and highly deformable even at room temperature, enabling the ability to accommodate the strain and/or stress of electrode particles during cycling by creeping and maintaining the good adhesion force with the electrode particles. Accordingly, the high stacking pressure during operation that is often called for in typical solid-state batteries, is not required.

Various embodiments of the concepts, systems, devices, structures and techniques sought to be protected are described herein with reference to the related drawings. Alternative embodiments can be devised without departing from the scope of the concepts, systems, devices, structures and techniques described herein. It is noted that various connections and positional relationships (e.g., over, below, adjacent, etc.) are set forth between elements in the following description and in the drawings. These connections and/or positional relationships, unless specified otherwise, can be direct or indirect, and the described concepts, systems, devices, structures and techniques are not intended to be limiting in this respect. Accordingly, a coupling of entities can refer to either a direct or an indirect coupling, and a positional relationship between entities can be a direct or indirect positional relationship.

The following definitions and abbreviations are to be used for the interpretation of the claims and the specification. As used herein, the terms “comprises,” “comprising, “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance, or illustration. Any embodiment or design described herein as “exemplary” is not necessarily to be construed as preferred or advantageous over other embodiments or designs. The term “one or more“ is understood to include any integer number greater than or equal to one, i.e. one, two, three, four, etc. The terms “a plurality” are understood to include any integer number greater than or equal to two, i.e. two, three, four, five, etc. The term “connection” can include an indirect “connection” and a direct “connection”.

References in the specification to “one embodiment, “an embodiment,” “an example embodiment,” etc., indicate that the embodiment described can include a particular feature, structure, or characteristic, but every embodiment can include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The terms “overlying,” “atop,” “on top, “positioned on” or “positioned atop” mean that a first element, such as a first structure, is present on a second element, such as a second structure, where intervening elements such as an interface structure can be present between the first element and the second element. The term “direct contact” means that a first element, such as a first structure, and a second element, such as a second structure, are connected without any intermediary conducting, insulating or semiconductor layers at the interface of the two elements. It should be noted that the term “selective to, “such as, for example, “a first element selective to a second element,” means that the first element can be etched and the second element can act as an etch stop.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

The terms “approximately” and “about” may be used to mean within ±20% of a target value in some embodiments, within ±10% of a target value in some embodiments, within ±5% of a target value in some embodiments, and yet within ±2% of a target value in some embodiments. The terms “approximately” and “about” may include the target value.

It is to be understood that the disclosed subject matter is not limited in its application to the details of construction and to the arrangements of the components set forth in the following description or illustrated in the drawings. The disclosed subject matter is capable of other embodiments and of being practiced and carried out in various ways. Also, it is to be understood that the phraseology and terminology employed herein are for the purpose of description and should not be regarded as limiting. As such, those skilled in the art will appreciate that the conception, upon which this disclosure is based, may readily be utilized as a basis for the designing of other structures, methods, and systems for carrying out the several purposes of the disclosed subject matter. Therefore, the claims should be regarded as including such equivalent constructions insofar as they do not depart from the spirit and scope of the disclosed subject matter.

Although the disclosed subject matter has been described and illustrated in the foregoing exemplary embodiments, it is understood that the present disclosure has been made only by way of example, and that numerous changes in the details of implementation of the disclosed subject matter may be made without departing from the spirit and scope of the disclosed subject matter.

What is claimed is:

1. A viscoelastic inorganic glass solid electrolyte material, comprising:
LiₓAlE_{y}G_{z}Jₘ, or NaₓAlE_{y}G_{z}Jₘ, wherein
E denotes one or more elements selected from the group consisting of boron (B), phosphorus (P), silicon (Si), lanthanum (La), or cerium (Ce),
G is a chalcogen element,
J is a halide element, and
wherein 0<x<5, 0<y<5, 0<z<5, and m=x+ny−2z+3,
wherein
n=3 when E denotes at least one element selected from the group consisting of La, Ce and B;
n=4 when E denotes Si; and
n=5 when E denotes P.

2. The viscoelastic inorganic glass solid electrolyte material of claim 1, wherein E is one element selected from the group consisting of B, P, Si, La, or Ce.

3. The viscoelastic inorganic glass solid electrolyte material of claim 1, wherein the chalcogen element comprises one of: oxygen (O); sulfur (S); or selenium (Se).

4. The viscoelastic inorganic glass solid electrolyte material of claim 1, wherein the halide element comprises one of: fluorine (F); chlorine (Cl); bromine (Br); or iodine (I).

5. The viscoelastic inorganic glass solid electrolyte material of claim 1, wherein E is B, P, or Si.

6. The viscoelastic inorganic glass solid electrolyte material of claim 1, wherein E is La or Ce and the following mathematical formula is satisfied m=x+3y−2z+3.

7. The viscoelastic inorganic glass solid electrolyte material of claim 1, wherein G denotes oxygen (O).

8. The viscoelastic inorganic glass solid electrolyte material of claim 7, wherein E is B, P, or Si.

9. The viscoelastic inorganic glass solid electrolyte material of claim 7, wherein E is La or Ce and the following mathematical formula is satisfied m=x+3y−2z+3.

10. The viscoelastic inorganic glass solid electrolyte material of claim 1, wherein E is P, G is O, J is Cl and the following mathematical formula is satisfied m=x+5y−2z+3.

11. A battery, comprising:
a positive electrode;
an electrolyte layer disposed on the positive electrode, wherein the electrolyte layer comprises a viscoelastic inorganic glass solid electrolyte material, comprising:
LiₓAlE_{y}G_{z}Jₘ, or NaₓAlE_{y}G_{z}Jₘ, wherein
E denotes at least one or more elements selected from the group consisting of boron (B), phosphorus (P), silicon (Si), lanthanum (La), or cerium (Ce),
G is a chalcogen element,
J is a halide element, and
wherein 0<x<5, 0<y<5, 0<z<5, and m=x+ny−2z+3,
wherein
n=3 when E denotes at least one element selected from the group consisting of La, Ce and B;
n=4 when E denotes Si;
n=5 when E denotes P; and
a negative electrode disposed on the electrolyte layer.

12. The battery of claim 11, wherein E is one element selected from the group consisting of B, P, Si, La, or Ce.

13. The battery of claim 11, wherein there are no crystalline peaks within the electrolyte layer when tested in an X-ray diffractometer.

14. The battery of claim 11, further comprising one or more passivation layers in the electrolyte layer.

15. The battery of claim 14, wherein the passivation layers contain either glass forming elements or their reduction products.

16. The battery of claim 11, wherein G denotes oxygen (O).

17. The battery of claim 11, wherein E is P, G is O, J is Cl and the following mathematical formula is satisfied m=x+5y−2z+3.

18. A method for forming a battery, comprising:
providing a positive electrode;
disposing an electrolyte layer on the positive electrode, wherein the electrolyte layer comprises a viscoelastic inorganic glass solid electrolyte material, comprising:
LiₓAlE_{y}G_{z}Jₘ, or NaₓAlE_{y}G_{z}Jₘ, wherein
E is phosphorus (P),
G is oxygen (O),
J is chlorine (Cl), and
the following mathematical formula is satisfied 0<x<5, 0<y<5, 0<z<5, and m=x+5y−2z+3;
rolling the electrolyte layer to a desired thickness by utilizing a hot forming process; and,
disposing a negative electrode on the electrolyte layer.

19. The method of claim 18, wherein rolling the electrolyte layer is carried out with a roller.

20. The method of claim 18, wherein there are no crystalline peaks within the electrolyte layer when tested in an X-ray diffractometer.
